(19) United States
(12) Patent Application Publication
(10) Pub. No.: US 2019/0052966 A1
(43) Pub. Date: Feb. 14, 2019

(54) HEADPHONE

(71) Applicant: Audio-Technica Corporation, Tokyo (JP)

(72) Inventors: Shigeo HARA, Tokyo (JP); Chung Hsien TSENG, Taoyuan (TW); Yi-Hsien LIN, Taoyuan (TW)

(21) Appl. No.: 16/032,237

(22) Filed: Jul. 11, 2018

(30) Foreign Application Priority Data
Aug. 10, 2017 (JP) 2017-155023

(51) Int. Cl. H04R 5/033; H04R 1/10; H04R 1/28; H04R 29/00

(52) U.S. Cl. CPC H04R 5/0335; H04R 1/1066; H04R 1/2819; H04R 7/02; H04R 29/001; H04R 2203/00; H04R 1/1075

(57) ABSTRACT

Provided is a headphone that can readily adjust the frequency response characteristics corresponding to the shape of a housing. The headphone includes a first sound emission unit and a head band. The first sound emission unit includes a driver unit, a baffle plate, a housing cover, and an acoustic resistor disposed between the driver unit and the housing cover. The housing cover defines a space together with the driver unit, and the baffle plate. The driver unit includes a diaphragm and a communication hole. The space has a first region and a second region. The diaphragm includes a main dome and an auxiliary dome. The communication hole includes a first communication hole facing the main dome and introducing first sound waves from the main dome to the first region and a second communication hole facing the auxiliary dome and introducing second sound waves from the auxiliary dome to the second region. The housing cover includes at least one vent hole establishing communication between the second region and the exterior of the housing cover.

### TECHNICAL FIELD

The present invention relates to a headphone.

### BACKGROUND ART

Among closed type headphones (hereinafter referred to as “headphone”), a headphone of an over-ear type, for example, is worn on the head of a user who listens to a music sound from a sound source such as a music player. The headphone has a pair of sound emission units (ear pieces) and a connection member connected to the sound emission units.

Each sound emission unit includes a driver unit, a baffle plate, and a housing. The driver unit, for example, converts electric signals (sound signals) from a sound source, such as a music player, to sound waves and outputs the sound waves. The driver unit is a dynamic driver unit which includes a diaphragm, a magnetic circuit, and a unit case. The baffle plate holds the driver unit. The housing accommodates the driver unit. The housing is attached to the baffle plate and defines a space (air chamber) together with the driver unit and the baffle plate.

In general, the frequency response characteristics of a headphone is adjusted by the volume of the housing (volume of the air chamber) or the acoustic resistors disposed in the housing (for example, refer to Japanese Unexamined Utility Model Application Publication No. 1984-121989 and Japanese Patent Application Laid-Open Publication No. 2003-179990).

The technique disclosed in Japanese Unexamined Utility Model Application Publication No. 1984-121989 covers a hole provided in a driver unit in which introduced sound waves from a diaphragm into an air chamber pass with damping fibric, such as non-woven fabric and adjusts the frequency response characteristics of the headphone by the material and/or thickness of the damping fabric.

The technique disclosed in Japanese Patent Application Laid-Open Publication No. 2003-179990 divides an air chamber into several cavities (a main cavity, a first auxiliary cavity, and a second auxiliary cavity) by an auxiliary housing accommodating the driver unit and multiple acoustic resistors segment, and adjusts the frequency response characteristics of the headphone by selecting various acoustic resistors.

### SUMMARY OF INVENTION

### Technical Problem

The technique disclosed in Japanese Unexamined Utility Model Application Publication No. 1984-121989 requires disassembly of the driver unit to partially replace the damping fabric. Thus, it is difficult to replace the damping fabric in the technique disclosed in Japanese Unexamined Utility Model Application Publication No. 1984-121989. As a result, this technique cannot adjust the frequency response characteristics of the headphone corresponding to various shapes and sizes (volumes) of the housing (air chamber).

On the other hand, in the technique disclosed in Japanese Patent Application Laid-Open Publication No. 2003-179990, the auxiliary housing should be attached to the baffle plate to dispose multiple acoustic resistors inside the air chamber. The shape and size of the acoustic resistors depend on the shape and size of the auxiliary housing. Thus, it is difficult to readily adjust the frequency response characteristics of the headphone corresponding to various shapes and sizes (volumes) of the housing (air chamber) in the technique disclosed in Japanese Patent Application Laid-Open Publication No. 2003-179990

An object of the present invention is to solve the problems described above, and to provide a headphone which can readily adjust frequency response characteristics corresponding to the shape of a housing.

### Solution to Problem

A headphone according to the present invention includes a head band, a first sound emission unit attached to one end of the head band, and a second sound emission unit attached to the other end of the head band. The first sound emission unit includes a driver unit, a baffle plate on which the driver unit is attached, a housing cover accommodating the driver unit, and an acoustic resistor disposed between the driver unit and the housing cover. The housing cover, defines a space together with the driver unit and the baffle plate. The driver unit includes a diaphragm and a communication hole introducing sound waves from the diaphragm to the space. The space includes a first region and a second region. The diaphragm includes a main dome and an auxiliary dome. The communication hole includes a first communication hole facing the main dome and introducing first sound waves from the main dome to the first region, and a second communication hole facing the auxiliary dome and introducing second sound waves from the auxiliary dome to the second region. The housing cover includes at least one vent hole establishing communication between the second region and the exterior of the housing cover.

### Advantageous Effects of Invention

According to the present invention, the frequency response characteristics of a headphone can be readily adjusted corresponding to the shape of a housing.

### BRIEF DESCRIPTION OF DRAWINGS

FIG. 1 is a perspective view of a headphone according to an embodiment of the present invention.

FIG. 2 is a view of a left sound emission unit of the headphone viewed along the arrow A in FIG. 1.

FIG. 3 is a cross-sectional view of the left sound emission unit taken along line B-B in FIG. 2.

FIG. 4 is an exploded perspective view of the left sound emission unit in FIG. 2.

FIG. 5 is a left side view of a baffle plate and a driver unit of the left sound emission unit in FIG. 2.

FIG. 6 is a right side view of a housing cover of the left sound emission unit in FIG. 2.

FIG. 7 is a cross-sectional view of the headphone taken along line C-C in FIG. 2.

FIG. 8 is a schematic view of paths of sound waves from a diaphragm of the headphone in FIG. 1.

### DESCRIPTION OF EMBODIMENTS

### Headphone

Embodiments of a headphone will now be described with reference to the attached drawings.

### Configuration of Headphone

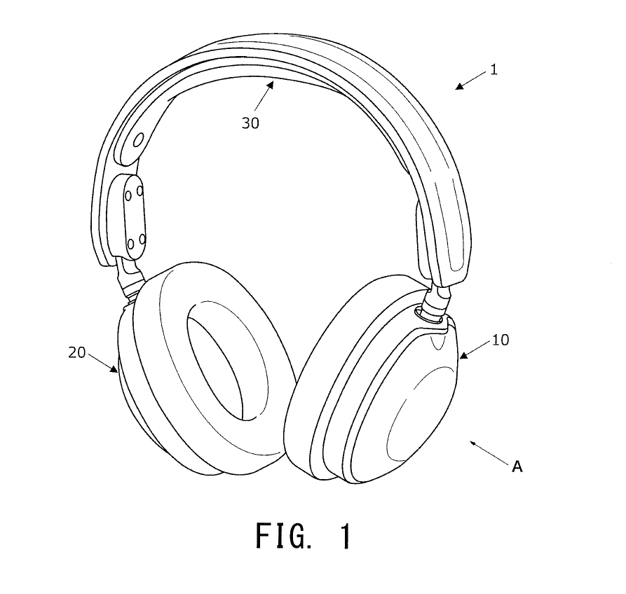

FIG. 1 is a perspective view of a headphone according to an embodiment of the present invention.

The headphone 1 is worn on the head of a user and outputs sound waves corresponding to sound signals from a sound source (not shown), for example, a portable music player to the ears of the user. The headphone 1 is a wired headphone that receives sound signals from a sound source via cables.

The headphone according to the present invention may be a wireless headphone that receives sound signals from a sound source via wireless communication.

In the following description, the top, bottom, right, left, front, and rear directions of the headphone 1 correspond to those of the headphone 1 worn on the head of the user (this state is hereinafter referred to as “worn state”). That is, for example, the left sound emission unit 10 described below is worn over the left ear of the user.

The headphone 1 includes a left sound emission unit 10, a right sound emission unit 20, and a head band 30. The left sound emission unit 10 constitutes a pair of sound emission units with the right sound emission unit 20.

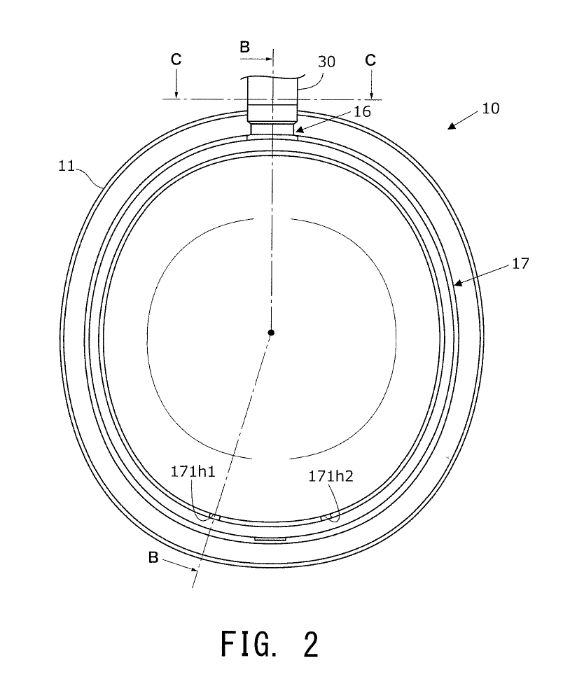

FIG. 2 is a view of the left sound emission unit 10 viewed along the arrow A in FIG. 1.

The left sound emission unit 10 is worn over the left ear of the user and outputs sound waves corresponding to sound signals from a sound source.

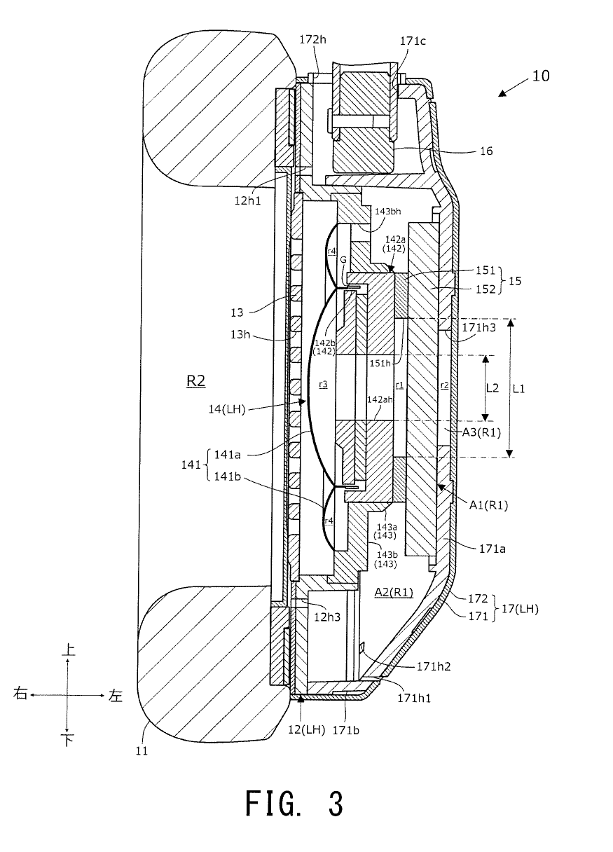

FIG. 3 is a cross-sectional view of the left sound emission unit 10 taken along line B-B in FIG. 2.

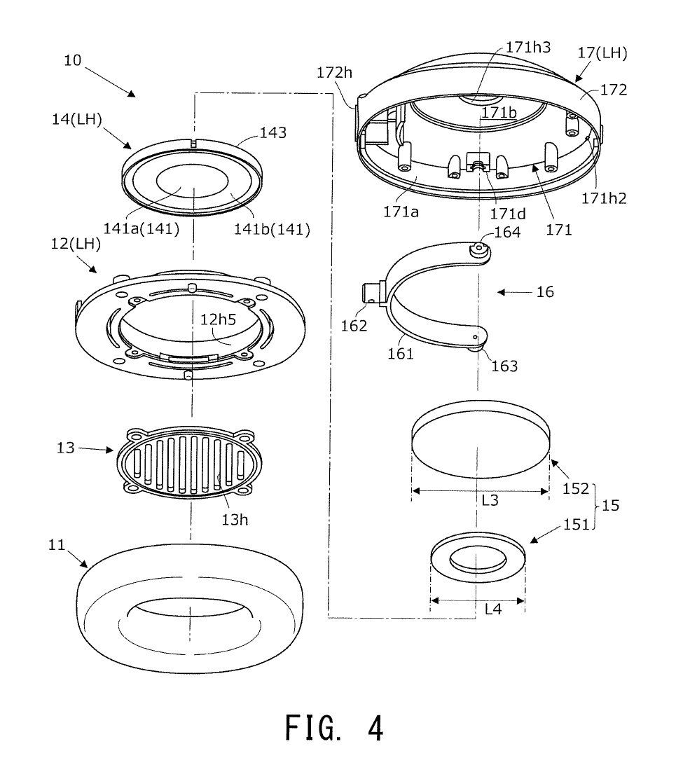

FIG. 4 is an exploded perspective view of the left sound emission unit 10.

The left sound emission unit 10 includes an ear pad 11, a baffle plate 12, a protector 13, a driver unit 14, an acoustic resistor 15, a connection member 16, and a housing cover 17. The baffle plate 12, the driver unit 14, and the housing cover 17 constitute a left housing LH.

The ear pad 11 is a buffer disposed between the left housing LH and the head of the user.

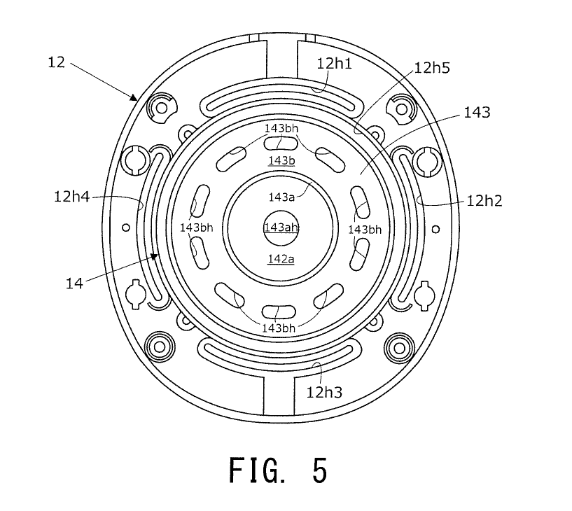

FIG. 5 is a left side view of the baffle plate 12 and the driver unit 14.

FIG. 5 is a view from the left of the baffle plate 12 and the driver unit 14 held by the baffle plate 12.

The baffle plate 12 holds the ear pad 11 (see FIG. 3) and the driver unit 14. The baffle plate 12 is composed of synthetic resin, for example. The baffle plate 12 has an oval shape in a view from the left. The baffle plate 12 has a first sound hole 12h1, a second sound hole 12h2, a third hole 12h3, a fourth sound hole 12h4, and a unit attachment hole 12h5.

The sound holes 12h1 to 12h4 each have an arcuate shape in a view from the left. The sound holes 12h1 to 12h4 are disposed around the unit attachment hole 12h5 at equal intervals in the circumferential direction of attachment hole 12h5. The function of the sound holes 12h1 to 12h4 will be described below.

The unit attachment hole 12h5 holds the driver unit 14. The unit attachment hole 12h5 has a circular shape in a view from the left. The unit attachment hole 12h5 is disposed in the center of the baffle plate 12 in a view from the left.

Referring back to FIGS. 3 and 4, the protector 13 protects the driver unit 14. The protector 13 has a disc shape. The protector 13 has multiple slitted sound hole 13h. The slitted sound hole 13h introduce sound waves from the driver unit 14 into a second space R2 described below.

The driver unit 14 converts sound signals from a sound source to sound waves and outputs the sound waves. The driver unit 14 includes a diaphragm 141, a driving part 142, and a frame 143.

The diaphragm 141 is configured to vibrate based on the driving (vibration) of the driving part 142 and outputs sound waves. The diaphragm 141 includes a main dome 141a and an auxiliary dome 141b.

The main dome 141a is configured to generate sound waves mainly in an intermediate frequency range (approximately 2 kHz) to a high frequency range (approximately 40 kHz). The main dome 141a has a circular shape in a view from the left and a dome shape protruding to the right in a cross-sectional view (left in FIG. 3).

The auxiliary dome 141b is configured to generate sound waves mainly in a low frequency range (approximately 200 Hz or lower). The auxiliary dome 141b has an annular shape in a view from the left and an arcuate shape protruding to the right in a cross-sectional view. The auxiliary dome 141b is connected to the outer circumference of the main dome 141a.

The driving part 142 is configured to drive (vibrates) the diaphragm 141 by driving (vibrating) in response to processing signals. The driving part 142 includes a magnetic circuit 142a and a voice coil 142b.

The magnetic circuit 142a has a magnetic gap G and a first communication hole 142ah. The magnetic circuit 142a generates a magnetic flux in the magnetic gap G. The first communication hole 142ah is a hole which extends through the magnetic circuit 142a in the right-left direction (right-left direction in FIG. 3). The first communication hole 142ah is disposed in the center of the magnetic circuit 142a. The magnetic circuit 142a is fit to a body portion 143a of the frame 143.

The voice coil 142b is configured to drive in response to the sound signals. The voice coil 142b, at the left face of the diaphragm 141 (the right face in FIG. 3), is attached to the boundary of the main dome 141a and the auxiliary dome 141b of the diaphragm 141.

The frame 143 holds the diaphragm 141 and the driving part 142.

The frame 143 is composed of synthetic resin, for example. The frame 143 has a shape of a circular hat in the plan view (see FIG. 5). The frame 143 includes a body portion 143a and a flange portion 143b. The body portion 143a has a cylindrical shape. The flange portion 143b has an annular shape. The flange portion 143b is disposed on the outer peripheral face of the opening end of the body portion 143a. The flange portion 143b has multiple communication holes (hereinafter referred to as “second communication holes”) 143bh for damping the diaphragm 141. The second communication holes 143bh, as shown in FIG. 5, are disposed at equal intervals in the flange portion 143b in the circumferential direction of the flange portion 143b at equal intervals.

Some of the second communication holes may be covered with an acoustic resistor, such as non-woven fabric (not shown), from the left. Among multiple second communication holes, the second communication holes covered with the acoustic resistor defines the frequency response characteristics of the headphone.

The diaphragm 141 is attached to the right face (the left face in FIG. 3) of the flange portion 143b of the frame 143. At this time, the first communication hole 142ah of the magnetic circuit 142a faces the main dome 141a. Multiple second communication holes 143bh in the flange portion 143b face the auxiliary dome 141b. The voice coil 142b is disposed in the magnetic gap G of the magnetic circuit 142a.

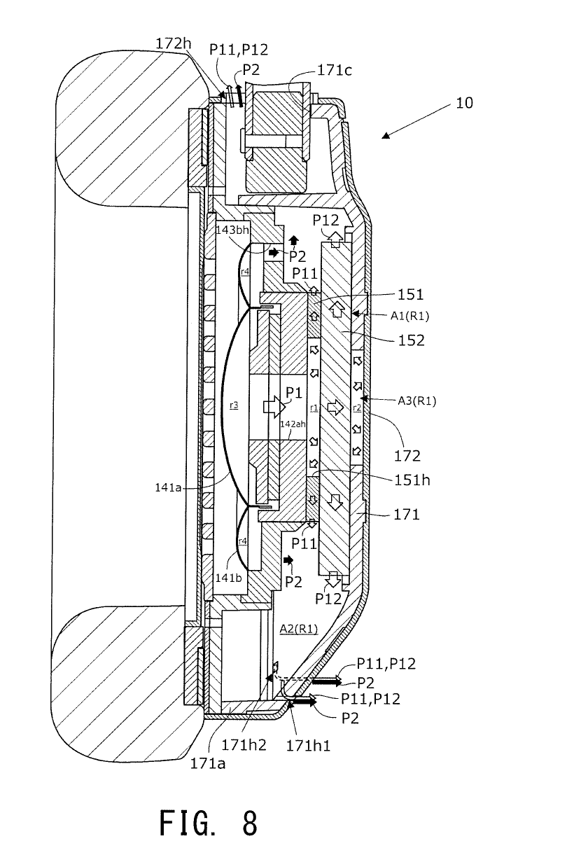

The acoustic resistor 15 attenuates the intermediate to high frequency components of sound waves P1 (hereinafter referred to as “first sound waves P1”) (see FIG. 8) that pass through the first communication hole 142ah of the magnetic circuit 142a among the sound waves from the diaphragm 141. That is, the acoustic resistor 15 is a sound absorber corresponding to intermediate to high frequency ranges. The acoustic resistor 15 includes a first acoustic resistor 151 and a second acoustic resistor 152.

The first acoustic resistor 151 is an acoustic resistor that transmits the high frequency component of the first sound waves P1. The first acoustic resistor 151 has a disc shape and an opening 151h in the center. That is, the first acoustic resistor 151 has a flat ring shape. The first acoustic resistor 151 is composed of, for example, synthetic resin, such as silicone rubber. The diameter L1 of the opening 151h (the inner diameter of the first acoustic resistor 151) is larger than the diameter L2 of the first communication hole 142ah of the magnetic circuit 142a.

The second acoustic resistor 152 is an acoustic resistor which transmits the intermediate frequency component of the first sound waves P1. The second acoustic resistor 152 has a disc shape. The second acoustic resistor 152 is composed of foamable resin, such as urethane, for example. The outer diameter L3 of the second acoustic resistor 152 is larger than the outer diameter L4 of the first acoustic resistor 151. The thickness of the second acoustic resistor 152 is larger than the thickness of the first acoustic resistor 151.

The connection member 16 connects the left housing LH and the head band 30 (see FIG. 1) and supports the left housing LH with respect to the head band 30. The connection member 16 includes an arcuate body portion 161, a rotary support portion 162, a first support portion 163, and a second support portion 164.

The rotary support portion 162 supports the body portion 161 from the head band 30. The body portion 161 is rotatable around the rotary support portion 162 relative to the head band 30. The rotary support portion 162 is disposed in the center of the body portion 161. The first support portion 163 and the second support portion 164 support the body portion 161 from the left housing LH. The body portion 161 pivots around the first support portion 163 and the second support portion 164 relative to the left housing LH. That is, the left housing LH is rotatable and pivotable relative to the head band 30 via the connection member 16.

The housing cover 17 accommodates the driver unit 14, the acoustic resistor 15, and the connection member 16. The housing cover 17 includes a housing member 171 and a cover member 172.

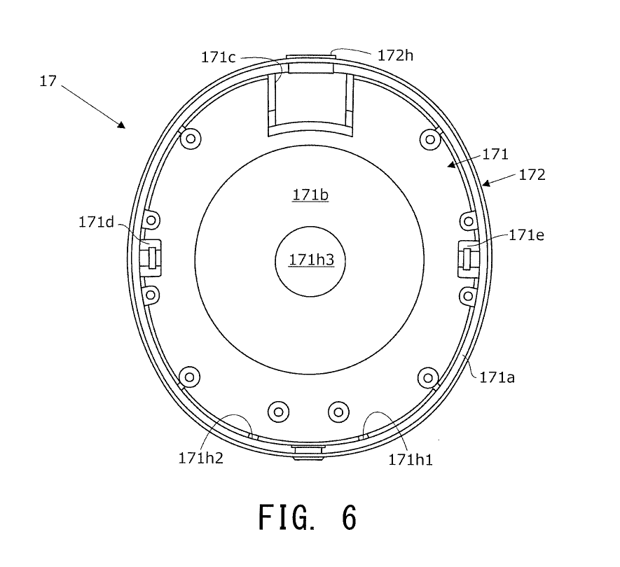

FIG. 6 is a right side view of the housing cover 17.

FIG. 6 is a view of the housing cover 17 from the right.

The housing member 171 accommodates the driver unit 14, the acoustic resistor 15, and the connection member 16 (see FIGS. 3 and 4). The housing member 171 has an opening end and an oval concave shape in a view from the right. The housing member 171 is composed of synthetic resin, such as acrylonitrile butadiene styrene (ABS), for example. The housing member 171 includes a peripheral face portion 171a, a bottom face portion 171b, a cutout portion 171c, a first connecting support portion 171d, a second connecting support portion 171e, a first vent hole 171h1, a second vent hole 171h2, and an opening 171h3.

The cutout portion 171c limits the movement of the rotary support portion 162 of the connection member 16 (pivoting of the connection member 16) (see FIG. 4). The cutout portion 171c is disposed in the upper portion of the peripheral face portion 171a of the housing member 171.

The first connecting support portion 171d supports the first support portion 163 of the connection member 16 (see FIG. 4). The second connecting support portion 171e supports the second support portion 164 of the connection member 16 (see FIG. 4).

The first vent hole 171h1 and the second vent hole 171h2 partially emit the sound waves from the driver unit 14 to the exterior of the housing cover 17. The first vent hole 171h1 and the second vent hole 171h2 are disposed in the lower portion of the housing member 171 in the front-back direction (right-left direction in FIG. 6) at predetermined intervals. The first vent hole 171h1 and the second vent hole 171h2 extend through the housing member 171 in the right-left direction (vertical direction in FIG. 6).

The opening 171h3 defines a depression according to the present invention together with the cover member 172. The opening 171h3 is disposed in the center of the bottom face portion 171b in a view from the right.

Referring back to FIG. 3, the cover member 172 protects the outer face of the housing member 171. The cover member 172 is composed of aluminum-based metal, for example. The cover member 172 has a limiting hole 172h.

The cover member 172 is attached to the outer face of the housing member 171 and covers the outer face of the housing member 171. As a result, the cover member 172 covers one end of the opening 171h3 of the housing member 171 and defines a depression together with the opening 171h3, as mentioned above. At this time, the cover member 172 exposes the first vent hole 171h1 and the second vent hole 171h2 to the exterior of the housing cover 17, for example, by slitted openings. Thus, the interior of the housing cover 17 is in communication with the exterior of the housing cover 17 through the first vent hole 171h1 and the second vent hole 171h2. That is, the first vent hole 171h1 and the second vent hole 171h2 function as vent holes according to the present invention.

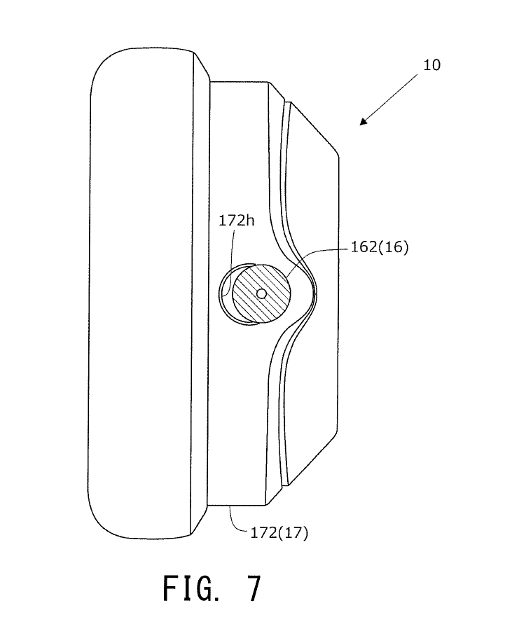

FIG. 7 is a cross-sectional view of the headphone 1 taken along line C-C in FIG. 2.

The limiting hole 172h limits the movement of the rotary support portion 162 of the connection member 16 (the pivoting of the connection member 16). The limiting hole 172h has a rectangular shape having short sides replaced with semi-circles. The limiting hole 172h is disposed in the top portion of the cover member 172 in a manner being aligned with the cutout portion 171c of the housing member 171 (see FIG. 6). As a result, the interior of the housing cover 17 is in communication with the exterior of the housing cover 17 through the cutout portion 171c and the limiting hole 172h. That is, the cutout portion 171c and the limiting hole 172h function as vent holes according to the present invention.

Referring back to FIG. 1, the right sound emission unit 20 is worn over the right ear of the user and outputs sound waves corresponding to sound signals from a sound source. The configuration of the right sound emission unit 20 is the same as that of the left sound emission unit 10.

The head band 30 connects a pair of sound emission units (that is the left sound emission unit 10 and the right sound emission unit 20). That is, the left sound emission unit 10 is attached to one end of the head band 30, and the right sound emission unit 20 is attached to the other end of the head band 30. The head band 30 has an articular shape conforming to the shape of the head of the user.

Assembly of Left Sound Emission Unit

The assembly of the left sound emission unit 10 will now be described with reference to FIGS. 3 and 4.

First, the protector 13 and the driver unit 14 are attached to the baffle plate 12. The driver unit 14 is fit to the unit attachment hole 12h5 of the baffle plate 12 while the diaphragm 141 is turned to the right (the left in FIG. 3). The protector 13 is attached to the right face of the baffle plate 12 (the left face in FIG. 3). The protector 13 covers the unit attachment hole 12h5 and faces the diaphragm 141.

Then, the connection member 16 is accommodated in the housing cover 17. The first support portion 163 is supported by the first connecting support 171d. The second support portion 164 is supported by the second connecting support portion 171e (see FIG. 6). The rotary support portion 162 extends through the cutout portion 171c and the limiting hole 172h of the housing cover 17. That is, the rotary support portion 162, which is a part of the connection member 16, is disposed in the cutout portion 171c and the limiting hole 172h.

In this way, causing to function the limiting hole 172h and the cutout portion 171c accommodating a part of the connection member 16 (the rotary support portion 162) also as vent holes in this way enables the reduction of the number of holes in the housing cover 17, and of each size of the first vent hole 171h1 and the second vent hole 171h2. As a result, flexibility increases in the positions of the vent holes, and the design of the headphone 1 is enhanced.

Then, the second acoustic resistor 152 and the first acoustic resistor 151, which constitute the acoustic resistor 15, are disposed in this order inside the housing cover 17. The second acoustic resistor 152 covers the opening 171h3 of the housing cover 17, that is the depression in the housing cover 17 from the right and comes into contact with the right face of the bottom face portion 171b of the housing member 171 (the left face in FIG. 3). As a result, the depression (opening 171h3) of the housing cover 17 faces the second acoustic resistor 152. The first acoustic resistor 151 is in contact with the second acoustic resistor 152. That is, the second acoustic resistor 152 is disposed between the first acoustic resistor 151 and the housing cover 17.

Then, the baffle plate 12 is then attached to the opening end of the housing cover 17. Thus, the opening end of the housing cover 17 is covered by the baffle plate 12 and the driver unit 14. As a result, the housing cover 17 defines a space (hereinafter referred to as “first space”) R1 together with the baffle plate 12, and the driver unit 14. The driver unit 14 is accommodated in the housing cover 17.

The first acoustic resistor 151 is in contact with the driver unit 14 and the second acoustic resistor 152. The second acoustic resistor 152 is in contact with the housing cover 17. That is, the first acoustic resistor 151 and the second acoustic resistor 152 are disposed between the driver unit 14 and the housing cover 17 (the bottom face portion 171b of the housing member 171). At this time, the first acoustic resistor 151 and the second acoustic resistor 152 are urged by the driver unit 14 and the housing cover 17. Thus, the driver unit 14 is fixed to the baffle plate 12 by the repulsive force of the first acoustic resistor 151 and the second acoustic resistor 152. As a result, the vibration of the driver unit 14 is suppressed when the driver unit 14 outputs sound waves (when the diaphragm 141 vibrates). When the sound waves from the driver unit 14 reach the housing cover 17, the vibration of the housing cover 17 in response to the sound waves is absorbed by the second acoustic resistor 152.

The first acoustic resistor 151, the internal space r1 of the opening 151h of the first acoustic resistor 151, the second acoustic resistor 152, and the internal space r2 in the depression (opening 171h3) are disposed on the left of the driver unit 14 (the right direction in FIG. 3). The first communication hole 142ah is in communication with the space r1. The depression faces the first communication hole 142ah through the second acoustic resistor 152. The central portion of the second acoustic resistor 152 faces the first communication hole 142ah, and the outer peripheral portion of the second acoustic resistor 152 faces the second communication holes 143bh.

A first space R1 is divided into a region (hereinafter referred to as “first region”) A1 in which the first acoustic resistor 151, the space r1, and the second acoustic resistor 152 are disposed, an annular region (hereinafter referred to as “second region”) A2 surrounding the first region A1 around the circumference of the acoustic resistor 15, and a region (hereinafter referred to as “third region”) A3 occupied by the space r2 in the depression. In other words, the first space R1 includes the first region A1, the second region A2, and the third region A3.

The first region A1 has a substantially circular shape. The second region A2 is adjacent to the first region A1 and has a substantially annular shape surrounding the first region A1 around the circumference of the acoustic resistor 15. The third region A3 is adjacent to the first region A1 and has a disc shape.

The second region A2 (first space R1) is in communication with the external space of the housing cover 17 through the first vent hole 171h1, the second vent hole 171h2, and the limiting hole 172h (cutout portion 171c) of the housing cover 17.

The internal (left) space r3 of the main dome 141a is in communication with the first region A1 (space r1) through the first communication hole 142ah. The internal (left) space r4 of the auxiliary dome 141b is in communication with the second region A2 through the second communication holes 143bh.

Then, the ear pad 11 is attached to the right face of the baffle plate 12. The ear pad 11 defines a space (hereinafter referred to as “second space”) R2 between the protector 13 and the side head portion of the user in a worn state.

The first space R1 (second region A2) is in communication with the second space R2 through the sound holes 12h1 to 12h4 of the baffle plate 12. Thus, the stiffness of the air in the first space R1 and the stiffness of the air in the second space R2 are balanced, thereby smoothening the vibration of the diaphragm 141.

Operation of Headphone

The operation of the headphone 1 will now be explained with an example of the left sound emission unit 10.

FIG. 8, in the cross-sectional view of the left sound emission unit 10 in FIG. 3, is a cross-sectional view schematically indicating the paths of sound waves from the diaphragm 141.

FIG. 8 indicates the paths of the first sound waves P1 with white arrows and the paths of second sound waves P2 with black arrows, among the sound waves from the diaphragm 141. The second sound waves P2 are sound waves passing through the second communication holes 143bh, among the sound waves from the diaphragm 141.

In response to vibration of the diaphragm 141, the first sound waves P1 from the main dome 141a and the second sound waves P2 from the auxiliary dome 141b are output respectively from the left of the diaphragm 141 (the right direction in FIG. 8). The first sound waves P1 are sound waves having a high sound pressure level mainly in the intermediate to high frequency ranges, and the second sound waves P2 are sound waves having a high sound pressure level mainly in the low frequency range.

The first sound waves P1 from the main dome 141a pass through the first communication hole 142ah to reach the first region A1 (space r1). That is, the first communication hole 142ah introduces the sound waves (first sound waves P1) from the diaphragm 141 (main dome 141a) into the first space R1 (first region A1).

The first sound waves P1 that have reached the first region A1 (space r1) are partially reflected by the second acoustic resistor 152, and the reflected first sound waves P1 travel toward the first acoustic resistor 151 through the space r1 and enter the first acoustic resistor 151. The other first sound waves P1 that have reached the first region A1, without being reflected at the second acoustic resistor 152, travel toward the first acoustic resistor 151 through the space r1, and enter the first acoustic resistor 151. The first sound waves P1 entering the first acoustic resistor 151 pass through the first acoustic resistor 151 and reach the second region A2. The sound waves P11 that have reached the second region A2 are the first sound waves P1, which an intermediate frequency range is attenuated (a sound pressure level reduced) by the first acoustic resistor 151.

The other first sound waves P1 that have reached the first region A1 enter the second acoustic resistor 152 and reach the third region A3 (space r2). That is, the opening 151h in the first acoustic resistor 151 partially introduces the first sound waves P1 into the second acoustic resistor 152. The first sound waves P1 that have reached the third region A3 are reflected at the cover member 172 and reenter the second acoustic resistor 152.

As described above, the housing member 171 is in contact with the second acoustic resistor 152. The cover member 172 is fixed to the housing member 171. Thus, when the cover member 172 reflects the first sound waves P1, the vibration of the cover member 172 (in resonance with the first sound waves P1) is transmitted to the second acoustic resistor 152 via the housing member 171 and absorbed by the second acoustic resistor 152. That is, the vibration of the housing cover 17 is suppressed. That is, sound waves in a low frequency range generated in response to the vibration of the housing cover 17 is suppressed. Thus, the frequency response characteristics of the low frequency range of the headphone 1 is enhanced.

The first sound waves P1 having reentered the second acoustic resistor 152 pass through the second acoustic resistor 152 and reach the second region A2. The sound waves P12 that have reached the second region A2 are the first sound waves P1 having a high frequency range attenuated by the second acoustic resistor 152.

Then, the second sound waves P2 from the auxiliary dome 141b pass through the second communication holes 143bh of the flange portion 143b and reach the second region A2. That is, the second communication holes 143bh introduce the sound waves (second sound waves P2) from the diaphragm 141 (auxiliary dome 141b) into the first space R1 (second region A2). The second sound waves P2 that have reached the second region A2 are sound waves, which a sound pressure level in the low frequency range is mainly high, as described above.

In this way, the first sound waves P1 from the main dome 141a are divided into the sound waves P11 which have an intermediate frequency range attenuated by the first acoustic resistor 151 (having a high sound pressure level in the high frequency range) and the sound waves P12 which have an high frequency range attenuated by the second acoustic resistor 152 (having a high sound pressure level in the intermediate frequency range), and the sound waves P11 and P12 reach the second region A2. On the other hand, the second sound waves P2 from the auxiliary dome 141b reach the second region A2 at a high sound pressure level in the low frequency range. That is, the sound waves P11, P12, and P2 output from the diaphragm 141 to the first space R1 reach the second region A2 in a state of a sound pressure level in a predetermined frequency range (low, intermediate, or high frequency range) is high.

By disposing the annular first acoustic resistor 151 and the disc-like second acoustic resistor 152 in the first region A1, the reflected distance of the first sound waves P1 having reached the first region A1, that is, the distance the first sound waves P1 traveled in the first region A1 is extended in comparison with when acoustic resistors are not disposed in the first region A1 or when a single acoustic resistor is disposed in the first region A1.

The sound waves P11, P12, and P2 that have reached the second region A2 are reflected at the baffle plate 12 and the housing cover 17 in the second region A2, travel toward the peripheral face portion 171a of the housing member 171, and are emitted to the exterior of the left housing LH (see FIG. 3) via vent holes, that is the first vent hole 171h1, the second vent hole 171h2, and the limiting hole 172h (cutout portion 171c). As a result, in the frequency response characteristics of the headphone 1, the sound pressure level in a predetermined frequency range (low, intermediate, or high frequency range) corresponding to the respective sound waves P11, P12, and P2 is increased.

The vent holes (first vent hole 171h1, second vent hole 171h2, and limiting hole 172h (vent hole)) is a path of the sound waves P11, P12, and P2 from the interior of the left housing LH (second region A2) to the exterior of the left housing LH. That is, the air in the vent holes functions as an acoustic resistor for the respective sound waves P11, P12, and P2 between the interior of the left housing LH (second region A2) to the exterior of the left housing LH. Normally, the acoustic resistance of the air in a vent hole depends on the size of the vent hole. As a result, in the frequency response characteristics of the headphone 1, for example, downsizing vent holes increases the sound pressure level in a low frequency range and upsizing vent holes decreases the sound pressure level in a low frequency range.

### CONCLUSION

According to the embodiments described above, the first sound waves P1 from the main dome 141a are reflected in the first region A1, pass through the acoustic resistor 15, and reach the second region A2. The first sound waves P1 (P11 and P12) that have reached the second region A2 are attenuated in a predetermined frequency range (intermediate or high frequency range) by the acoustic resistor 15. On the other hand, the second sound waves P2 from the auxiliary dome 141b reach the second region A2 without being attenuated. The respective sound waves P11, P12, and P2 that have reached the second region A2 are emitted to the exterior of the housing cover 17 (left housing LH) from the vent holes, that is the first vent hole 171h1, the second vent hole 171h2, and the limiting hole 172h (the cutout portion 171c). As a result, in the frequency response characteristics of the headphone, the sound pressure level in a predetermined frequency range (low, intermediate, or high frequency range) is increased.

The acoustic resistor 15 includes the first acoustic resistor 151 and the second acoustic resistor 152. The material of the first acoustic resistor 151 differs from the material of the second acoustic resistor 152. Thus, the first sound waves P1 passing through the acoustic resistor 15 are divided into two sound waves P11 and P12 having different frequency ranges (intermediate and high frequency ranges) attenuated by the acoustic resistor 15 in the first region A1.

In this way, the headphone 1 adjusts the sound pressure level of the first sound waves P1 in the first region A1 by the first acoustic resistor 151 and the second acoustic resistor 152. In the second region A2, the headphone 1 emits the respective sound waves P11, P12, and P2 to the exterior of the left housing LH through the vent holes 171h1, 171h2, and 172h (171c). As a result, in the frequency response characteristics of the headphone 1, the sound pressure level in a predetermined frequency range (low, intermediate, or high frequency range) is increased. The first region A1 and the second region A2 are defined by shapes of the first acoustic resistor 151 and the second acoustic resistor 152, respectively. The first acoustic resistor 151 and the second acoustic resistor 152 are disposed between the driver unit 14 and the housing cover 17 and can be readily replaced. That is, the headphone according to the present invention can readily adjust the frequency response characteristics corresponding to the shape of the left housing LH by replacement of the acoustic resistor 15 disposed in the first region A1 and/or adjustment of the sizes of the vent holes.

The first acoustic resistor 151 further has an annular shape and the opening 151h that introduces the first sound waves P1 into the first acoustic resistor 151 and the second acoustic resistor 152 respectively. The diameter of the opening 151h is larger than the diameter of the first communication hole 142ah. Thus, the first sound waves P1 having reached the first region A1 enter the second acoustic resistor 152 and travel through the space r1 while being reflected between the second acoustic resistor 152 and the driver unit 14 toward the first acoustic resistor 151. That is, the reflected distance of the first sound waves P1 which have reached the first region A1 (distance travelled by the first sound waves P1) is extended corresponding to the diameter of the opening 151h. As a result, in the frequency response characteristics of the headphone 1, the sound pressure level at a predetermined frequency corresponding to the reflected distance of the first sound waves P1 is improved. In other words, the headphone according to the present invention, by modification of the shapes of the first acoustic resistor 151 and the second acoustic resistor 152, adjusts the reflected distance of the first sound waves P1 and improves the sound pressure level at a predetermined frequency corresponding to the reflected distance.

The housing cover 17 further includes the depression defined by the opening 171h3 in the housing member 171 and the cover member 172. The first sound waves P1 having passed through the second acoustic resistor 152 are reflected at a metal plate (cover member 172) in the internal space r2 of the depression. As a result, the first sound waves P1 are reflected at the cover member 172 without absorption of the intermediate and high frequency ranges by the housing member 171. The reflected distance of the first sound waves P1 that have reached the space r2 is extended by the reflected distance of the first sound waves P1 in the space r2.

It should be noted that, in the embodiments described above, the material of the first acoustic resistor 151 differs from the material of the second acoustic resistor 152. Alternatively, the material of the first acoustic resistor may be the same as the material of the second acoustic resistor. In such a case, the first sound waves passing through the acoustic resistor and reaching the second region are sound waves of which only a predetermined frequency range is attenuated. As a result, in the frequency response characteristics of the headphone 1 the sound pressure levels in the low frequency range and the predetermined frequency range is increased.

The respective shape and size of the first and the second acoustic resistors are not limited to those in the embodiments. That is, the shape and size of the first and the second acoustic resistors, for example, may be appropriately varied to achieve predetermined frequency response characteristics of the headphone.

The bottom face portion of the housing member may further include a circular rib for positioning of the second acoustic resistor. In such a case, the rib is disposed, for example, on the outer peripheral edge of the right bottom face portion.

First communication holes may be provided in the magnetic circuit and the frame. That is, for example, the frame may have a shape of a hat having a opening defining a first communication hole together with an opening in the magnetic circuit in the center.

1. A headphone comprising:
a head band;
a first sound emission unit attached to one end of the head band; and
a second sound emission unit attached to the other end of the head band, wherein
the first sound emission unit comprises:
a driver unit;
a baffle plate on which the driver unit is attached;
a housing cover accommodating the driver unit, the housing cover having an exterior; and
an acoustic resistor disposed between the driver unit and the housing cover,
the housing cover defining a space together with the driver unit and the baffle plate,
the driver unit comprises:
a diaphragm; and
a communication hole introducing sound waves from the diaphragm into the space,
the space includes:
a first region; and
a second region adjacent to the first region,
the diaphragm comprises:
a main dome; and
an auxiliary dome,
the communication hole includes:
a first communication hole facing the main dome and introducing first sound waves from the main dome to the first region; and
a second communication hole facing the auxiliary dome and introducing second sound waves from the auxiliary dome to the second region,
the housing cover comprises:
at least one vent hole establishing communication between the second region and the exterior of the housing cover.

2. The headphone according to claim 1, wherein the acoustic resistor is disposed in the first region.

3. The headphone according to claim 1, wherein
the first sound emission unit comprises a connection member connecting the first sound emission unit to the head band; and
the connection member is partially disposed in the at least one vent hole.

4. The headphone according to claim 1, wherein the acoustic resistor is in contact with the driver unit and the housing cover.

5. The headphone according to claim 1, wherein
the acoustic resistor comprises:
a first acoustic resistor; and
a second acoustic resistor disposed between the first acoustic resistor and the housing cover.

6. The headphone according to claim 5, wherein the first acoustic resistor and the second acoustic resistor comprise different materials.

7. The headphone according to claim 5, wherein the first acoustic resistor and the second acoustic resistor comprise the same material.

8. The headphone according to claim 5, wherein,
the first acoustic resistor is in contact with the driver unit, and
the second acoustic resistor is in contact with the housing cover.

9. The headphone according to claim 5, wherein
the first acoustic resistor comprises an opening, and
the opening introduces the first sound waves into the second acoustic resistor.

10. The headphone according to claim 9, wherein,
the first acoustic resistor has an annular shape,
the second acoustic resistor has a disc shape, and
the outer diameter of the second acoustic resistor is smaller than the outer diameter of the first acoustic resistor.

11. The headphone according to claim 9, wherein the second acoustic resistor faces the first communication hole and the second communication hole.

12. The headphone according to claim 9, wherein the diameter of the opening is larger than the diameter of the first communication hole.

13. The headphone according to claim 1, wherein
the housing cover comprises a depression, and
the depression faces the acoustic resistor.

14. The headphone according to claim 1, wherein
the housing cover comprises a depression, and
the depression faces the first communication hole.

15. The headphone according to claim 1,
the driver unit comprises:
a magnetic circuit vibrating the diaphragm; and
a frame holding the magnetic circuit, wherein
the magnetic circuit comprises the first communication hole, and
the frame comprises the second communication hole.
